(19) United States
(12) Patent Application Publication
(10) Pub. No.: US 2022/0102769 A1
(43) Pub. Date: Mar. 31, 2022

(54) ARCHITECTURE FOR BATTERY SELF HEATING

(71) Applicant: GM Global Technology Operations LLC, Detroit, MI (US)

(72) Inventors: Neeraj S. Shidore, Novi, MI (US); Lei Hao, Troy, MI (US); Chandra S. Namuduri, Troy, MI (US); Suresh Gopalakrishnan, Troy, MI (US); Meixian Wang, Troy, MI (US); Venkatesh Gopalakrishnan, ROCHESTER HILLS, MI (US)

(21) Appl. No.: 17/038,603

(22) Filed: Sep. 30, 2020

(51) Int. Cl. H01M 10/44; H02J 7/04; H02J 7/00

(52) U.S. Cl. CPC H01M 10/443; H02J 7/04; H02M 3/1582; H02J 7/0013; H02J 2207/20; H02J 7/0047

(57) ABSTRACT

A method for preconditioning a battery pack at cold ambient temperatures is disclosed. The battery pack includes one or more battery cells. The method includes the steps of determining a desired rate of temperature rise for a battery cell, determining a desired cell current based on the desired rate of temperature rise, and determining a desired pack current based on the desired cell current and the battery pack configuration. The method further includes using a controller to control a current generation device to provide the desired pack current to the battery pack, wherein the current generation device generates an alternating current.

### INTRODUCTION

The present disclosure relates generally to thermal management systems for rechargeable energy storage systems (RESS), such as battery packs in vehicles.

Automotive vehicles are available that use an RESS, such as a battery pack, to store large amounts of energy to provide propulsion to the vehicle. These vehicles may include, for example, plug-in hybrid electric vehicles, electric vehicles with an internal combustion engine that is used as a generator for battery charging, and battery-electric vehicles. To maximize the charging capacity and life of a battery pack, it is desirable to provide a battery thermal management system to maintain the temperature of the battery pack in a desired range over a wide range of ambient temperatures.

Uncontrolled operation of a battery at low battery temperatures, in particular charging for lithium-ion battery chemistries, may result in lithium plating or cell damage that could eventually lead to reduced performance or degraded life during subsequent operation. Conventional approaches to controlling battery temperature at low ambient temperatures include convective heating, which may use an electric heating element to heat a fluid (liquid or air) that is provided to the battery enclosure to increase the temperature of battery cells within the enclosure.

While current battery temperature control systems achieve their intended purpose, there is a need for a new and improved system and method for controlling battery temperature at low ambient temperatures.

### SUMMARY

According to several aspects, a method is disclosed for preconditioning a battery pack at cold ambient temperatures, with the battery pack including one or more battery cells. The method includes the steps of determining a desired rate of temperature rise for a battery cell, determining a desired cell current based on the desired rate of temperature rise, and determining a desired pack current based on the desired cell current and the battery pack configuration. The method further includes using a controller to control a current generation device to provide the desired pack current to the battery pack, wherein the current generation device generates an alternating current.

In an additional aspect of the present disclosure, the desired cell current is determined based on an AC impedance of the battery cell.

In another aspect of the present disclosure, the AC impedance of a battery cell is determined based on the temperature of the battery cell and the state of charge of the battery cell.

In another aspect of the present disclosure, the current generation device comprises a boost-buck converter that includes a plurality of switches.

In a further aspect of the present disclosure, a controller controls the on or off state of each of the plurality of switches.

In an additional aspect of the present disclosure, the current generation device comprises an inverter electrically connected to the battery pack, the inverter having a plurality of switches that are electrically connected to windings in an electric motor. The on or off state of each of the plurality of switches are controlled to generate the desired pack current to the battery pack.

In another aspect of the present disclosure, the battery pack includes a first sub-pack and a second sub-pack, and the current generation device is a DC/DC converter electrically connected to both the first sub-pack and the second sub-pack.

In another aspect of the present disclosure, the phase of the pack current delivered to the first sub-pack is opposite the phase of pack current delivered to the second sub-pack.

In a further aspect of the present disclosure, the battery pack is connectable to the power grid for DC charging, and the first sub-pack is connected in parallel with the second sub-pack for supplying DC current to a load. A plurality of switches are controllable to a first configuration in which the first sub-pack is connected in parallel with the second sub-pack for DC charging from the grid and to a second configuration in which the first sub-pack is connected in series with the second sub-pack for DC charging from the grid.

In an additional aspect of the present disclosure, the battery pack is connectable to the power grid for DC charging, the first sub-pack is connected in series with the second sub-pack for supplying DC current to a load, and the first sub-pack is connected in series with the second sub-pack for DC charging from the grid.

In another aspect of the present disclosure, the current generation device includes a DC/DC converter electrically connected to an ultracapacitor.

In another aspect of the present disclosure, the current generation device includes a switch in series with an inductor.

In a further aspect of the present disclosure, the alternating current is generated at a frequency that is determined based on the temperature of the battery cell and the state of charge of the battery cell.

In another aspect of the present disclosure, the frequency is between 10 Hz and 1000 Hz.

In an additional aspect of the present disclosure, the battery pack is configured to provide power to a traction motor in an electric vehicle.

According to several aspects, a controller includes a processor and a non-transitory machine-readable storage device containing instructions that, when executed by the processor, cause the processor to execute the aforementioned method.

According to several aspects, an automotive vehicle includes a traction motor system, a battery pack including one or more battery cells electrically connectable to the traction motor system, and a current generation device configurable to deliver AC current to the battery pack. The automotive vehicle further includes a controller electrically connected to the current generation device. The controller is configured to determine a desired rate of temperature rise for a battery cell, determine a desired cell current based on the desired rate of temperature rise, determine a desired pack current based on the desired cell current and the battery pack configuration, and control the current generation device to provide the desired pack current to the battery pack from the current generation device.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a depiction of an algorithm for calculating current required for battery heating according to an exemplary embodiment;

FIG. 2 is a depiction of an electrical architecture using a buck-boost converter to generate alternating current for the battery according to an exemplary embodiment;

FIG. 3 is a depiction of a controller that includes control logic to convert battery current requirement into switch control for a buck-boost converter according to an exemplary embodiment;

FIG. 4 is a depiction of an electrical architecture using inverter switches and a motor winding to generate alternating current through the battery according to an exemplary embodiment;

FIG. 5 is a depiction of an electrical architecture for dual battery packs or sub-packs according to an exemplary embodiment;

FIG. 6 is a depiction of an electrical architecture for dual battery packs or sub-packs when the sub-packs are always in parallel in driving mode according to an exemplary embodiment;

FIG. 7 is a depiction of an electrical architecture for dual battery packs or sub-packs when the sub-packs are always in series in driving and charging mode according to an exemplary embodiment;

FIG. 8 is a depiction of an electrical architecture with a battery pack in combination with an ultracapacitor according to an exemplary embodiment; and

FIG. 9 is a depiction of an electrical architecture with a switch and an inductor to generate alternating current for battery heating according to an exemplary embodiment.

### DETAILED DESCRIPTION

The following description is merely exemplary in nature and is not intended to limit the present disclosure, application, or uses.

Automotive vehicles are available that use an RESS, such as a battery pack, to store large amounts of energy to provide propulsion to the vehicle. These vehicles may include, for example, a plug-in hybrid electric vehicle (EV), electric vehicles with an internal combustion engine that is used as a generator for battery charging, and battery-electric vehicles. To improve the driving range of an electric vehicle, regenerative braking is used to slow a moving vehicle by converting its kinetic energy into electrical energy that can be used to charge the vehicle battery.

Uncontrolled operation of a battery at low battery temperatures, in particular charging for lithium-ion battery chemistries, may result in lithium plating or cell damage that could eventually lead to reduced performance or degraded life during subsequent operation. For example, to prevent battery damage caused by charging of lithium-ion batteries at low battery temperatures, it may be necessary to limit charging current provided to the battery by regenerative braking.

To maximize the charging capacity and life of a battery pack, it is desirable to provide a battery thermal management system to maintain the temperature of the battery pack in a desired range over a wide range of ambient temperatures. Conventional approaches to controlling battery temperature at low ambient temperatures include convective heating, which may use an electrically powered resistive heating element to heat a fluid (liquid or air) that is provided to the battery enclosure to increase the temperature of battery cells within the enclosure. These conventional approaches have several disadvantages. Convective heating is relatively inefficient and slow, and can result in non-uniform heating of the battery cells depending on the location of a cell relative to the convective heat exchange surface. The cost of a resistive heating element and associated wiring is also an issue.

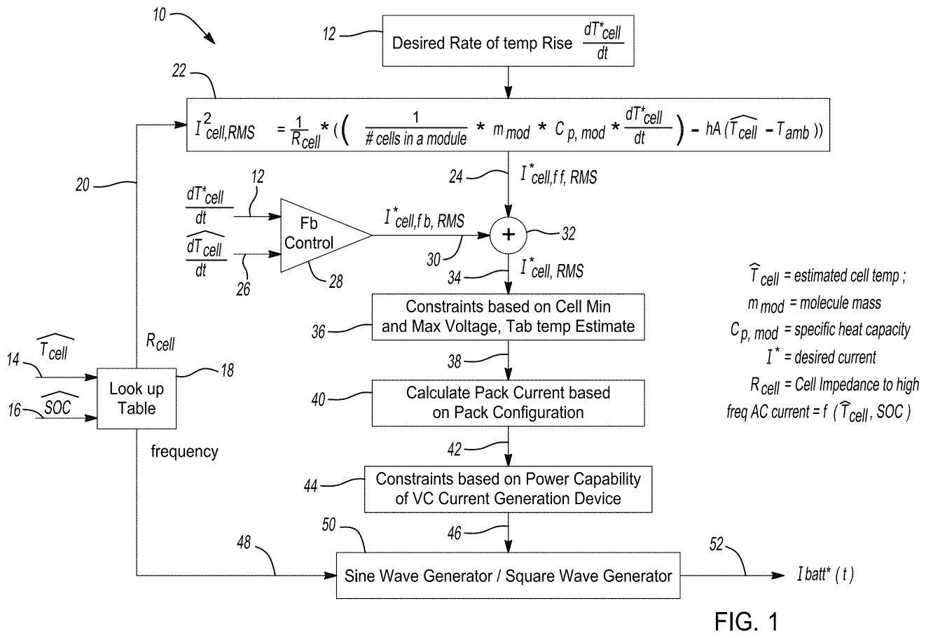

Referring to FIG. 1, an algorithm 10 for calculating desired current for battery heating according to an exemplary embodiment is depicted. A first input to the algorithm 10 is a desired rate of cell temperature rise 12. Additional inputs to the algorithm 10 include an estimated cell temperature 14 and an estimated state of charge 16. As used herein, the term “state of charge” is understood to represent the level of charge of an electric battery relative to its capacity. The estimated cell temperature 14 and estimated state of charge 16 are inputs to a lookup table 18. One output of the lookup table 18 is a value 20 which represents the cell impedance to AC current. Another output of the lookup table 18 is a frequency value 48, the use of which will be described below. The frequency value is chosen based on the response time of electrochemical reactions within the battery cells, and the electrochemical reaction rates depend on the cell temperature and the cell state of charge. In a non-limiting example, the desired AC frequency is in the range of 10 Hz to 1000 Hz. In an alternative embodiment not shown in FIG. 1, the cell impedance 20 and the frequency value 48 may also be a function of estimated RMS cell current in addition to cell temperature 14 and state of charge 16.

With continued reference to FIG. 1, the desired rate of temperature rise 12 and the value 20 which represents the cell impedance to AC current are used as inputs to a calculation shown in algorithm block 22, the output of which is a result 24 representing a feedforward RMS value of desired cell current. The desired rate of cell temperature rise 12 and an estimated value of actual rate of cell temperature rise 26 are used as inputs to a feedback control block 28, the output of which is a result 30 representing a feedback RMS value of desired cell current. The result 24 representing a feedforward RMS value of desired cell current and the result 30 representing a feedback RMS value of desired cell current are combined in summer 32 to produce a result 34 representing desired cell RMS current.

Continuing to refer to FIG. 1, the result 34 representing desired cell RMS current is provided to algorithm block 36, which applies constraints based on minimum and maximum cell voltage and estimated cell tab temperature to produce a constrained desired cell RMS current value 38. This constrained desired cell RMS current value 38 is provided to algorithm block 40, which calculates a result 42 representing desired battery pack current based on the configuration of cells in the battery pack. The configuration of cells in the battery pack may include the number of cells in the battery pack and/or the arrangement of how cells are connected in series and/or in parallel. The result 42 representing desired battery pack current is provided to algorithm block 44 which applies constraints based on the power capability of the AC current generation device used in conjunction with the algorithm 10. Algorithm block 44 provides a result 46 representing the desired controlled RMS value of the battery pack current, which along with frequency value 48 is provided to a waveform generator block 50 to provide a result 52 representing desired current to the battery as a function of time.

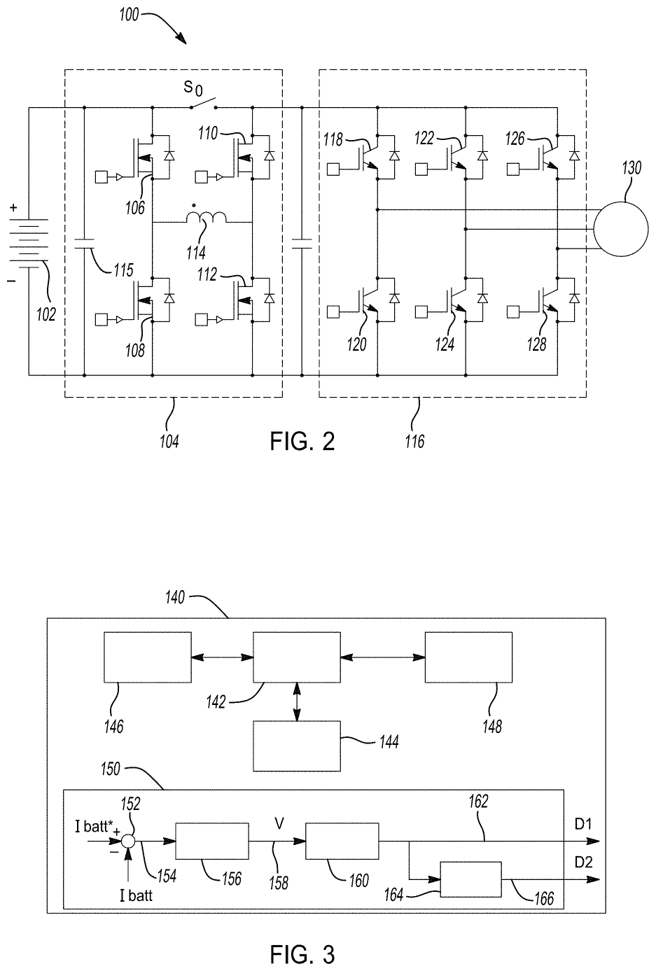

FIG. 2 depicts a non-limiting example of an electrical architecture 100 to generate alternating current for the battery 102. As used herein, the term “alternating current” refers to sinusoidal current, square wave current, pulse current, or current of any combination of sine wave harmonics so as to make a non-DC waveform. The exemplary electrical architecture 100 uses a buck-boost DC/DC converter generally indicated by the dashed box 104. The buck-boost converter 104 includes a first switch 106, a second switch 108, a third switch 110, and a fourth switch 112 in an H-bridge configuration, with an inductor 114 connected to the switches 106, 108, 110, 112 as shown. A controller (not shown) is used to control the on and off states of the switches 106, 108, 110, 112 to control current through the inductor 114 to provide an alternating current to alternately charge and discharge the battery 102. During a first portion of the AC cycle, electrochemical energy from the battery 102 is converted to electromagnetic energy stored in the magnetic field of the inductor 114 and electrostatic energy in the capacitor 115. During a second portion of the AC cycle, energy released by the collapsing magnetic field of the inductor 114 and the electrostatic energy in capacitor 115 is provided to the battery 102 where it is converted to electrochemical energy. Because each battery cell has an associated resistance R_{cell}, the RMS current I_{RMS} results in electrical power dissipated as heat within the battery cell, the power in a cell being equal to (I_{RMS})²*R_{cell}.

With continued reference to FIG. 2, the exemplary electrical architecture 100 includes an inverter generally indicated by the dashed box 116. The inverter 116 includes a first inverter switch 118, a second inverter switch 120, a third inverter switch 122, a fourth inverter switch 124, a fifth inverter switch 126, and a sixth inverter switch 128. A controller (not shown) is used to control the on and off states of the switches 118, 120, 122, 124, 126, 128 to control current to a 3 phase traction motor 130 in an electric vehicle application.

FIG. 3 is a depiction of an exemplary controller 140 that includes control logic 150 to convert battery current requirement into switch control for the exemplary buck-boost converter 104 of FIG. 2. The controller 140 is a non-generalized, electronic control device having a preprogrammed digital computer or processor 142, memory or non-transitory computer readable medium 144 used to store data such as control logic, software applications, instructions, computer code, data, lookup tables, etc. The controller 140 is also shown with input ports 146 and output ports 148. The computer readable medium 144 includes any type of medium capable of being accessed by a computer, such as read only memory (ROM), random access memory (RAM), a hard disk drive, a compact disc (CD), a digital video disc (DVD), or any other type of memory. A “non-transitory” computer readable medium 144 excludes wired, wireless, optical, or other communication links that transport transitory electrical or other signals. A non-transitory computer readable medium 144 includes media where data can be permanently stored and media where data can be stored and later overwritten, such as a rewritable optical disc or an erasable memory device. Computer code includes any type of program code, including source code, object code, and executable code. The processor 142 is configured to execute the code or instructions. The code or instructions may be stored within the memory 144 or in additional or separate memory. The control logic 150 is depicted as being part of the controller 140. It is to be understood that the control logic 150 could alternatively be a separate module operatively connected to the controller 140.

Continuing to refer to FIG. 3, within the control logic 150 an actual measured battery heating current Ibatt is subtracted from the desired battery current Ibatt* in a summing junction 152. The resulting error signal 154 is provided to a current regulator 156, depicted as a proportional plus integral (PI) controller. The current regulator output 158 is provided to a PWM generator circuit 160, which outputs a first pulse width modulated signal 162 (also labeled D1). The first pulse width modulated signal 162 is provided to a logic inverter 164 to produce a second pulse width modulated signal 166 (also labeled D2). Referring to FIG. 3 and again to FIG. 2, the pulse width modulated signals 162 and 166 can be used to control the on and off states of the switches 106, 108, 110, 112 to control current through the inductor 114. By controlling the switches 106, 108, 110, 112, current through the inductor 114 can be turned off, turned on in a left-to-right direction relative to the depiction in FIG. 2, or turned on in a right-to-left direction relative to the depiction in FIG. 2, thereby enabling an alternating current to be supplied to the battery 102.

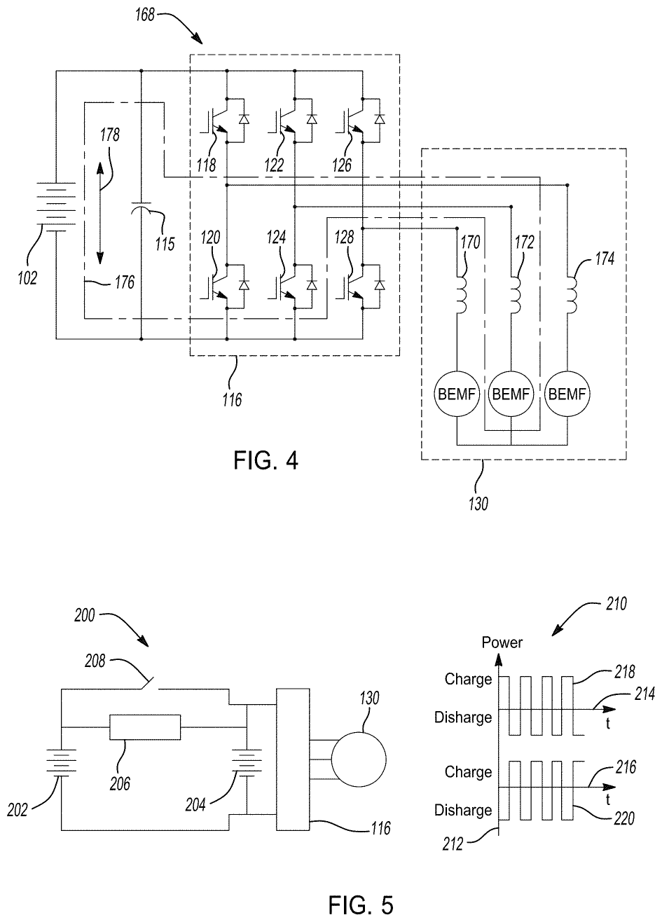

FIG. 4 is a depiction of an alternative electrical architecture 168 to generate alternating current through the battery 102 according to an exemplary embodiment. Referring to FIG. 4 and again to FIG. 2, the battery 102 and the inverter 116 as described relative to FIG. 2 are depicted. The 3 phase traction motor 130 shown in FIG. 2 is shown in further detail in FIG. 4 with a first motor winding 170, a second motor winding 172, and a third motor winding 174. Using appropriate control signals to the inverter switches 118, 120, 122, 124, 126, 128, and using the inductance of a motor winding 172, a charging current as indicated by the current path 176 can be generated to the battery 102. The charging current in the current path 176 can be generated as an AC current, as indicated by the double-headed current direction arrow 178. The electrical architecture 168 uses the motor winding 172 as an energy storage component. During a first portion of the AC cycle, electrochemical energy from the battery 102 is converted to electromagnetic energy stored in the magnetic field of the motor winding 172 and electrostatic energy in the capacitor 115. During a second portion of the AC cycle, energy released by the collapsing magnetic field of the motor winding 172 and the electrostatic field across the capacitor 115, and is provided to the battery 102 where it is converted to electrochemical energy. Compared to the electrical architecture 100 shown in FIG. 2, the electrical architecture 168 shown in FIG. 4 has the advantage that no additional hardware is needed to generate the AC charging current to the battery 102.

FIG. 5 is a depiction of an electrical architecture 200 for dual battery packs or sub-packs according to an exemplary embodiment. As used herein, the term “sub-pack” is understood to refer to a first battery structure that is configured to be electrically connected, in series or in parallel, to at least a second battery structure to define the battery 102. Referring to FIG. 5, the electrical architecture 200 includes a first battery pack or sub-pack 202 and a second battery pack or sub-pack 204. The electrical architecture 200 also includes a DC/DC converter 206 and a bypass switch 208. FIG. 5 also depicts an inverter 116 and a traction motor 130, operation of both of which were previously discussed relative to FIG. 2. Operation of the electrical architecture 200 is generally illustrated in the graph 210, in which the vertical axis is a split axis representing charging and discharging power levels for each of the battery packs/sub-packs 202, 204, and in which the horizontal axes 214, 216 represent time. The first trace 218 represents charging and discharging of the first battery pack/sub-pack 202, and the second trace 220 represents charging and discharging cycles of the second battery pack/sub-pack 204. By appropriate control of the DC/DC converter 206, the charging power to the first battery pack/sub-pack 202 can be 180 degrees out of phase with the charging power to the second battery pack/sub-pack 204 as indicated by the traces 218, 220. The electrical architecture 200 also includes a bypass switch 208. The bypass switch 208 is set to an open state when AC power for battery heating is being delivered with opposite phases to the first battery pack or sub-pack 202 and the second battery pack or sub-pack 204. The bypass switch 208 is set to a closed state when DC power is being delivered to the inverter 116 to allow operation of the traction motor 130.

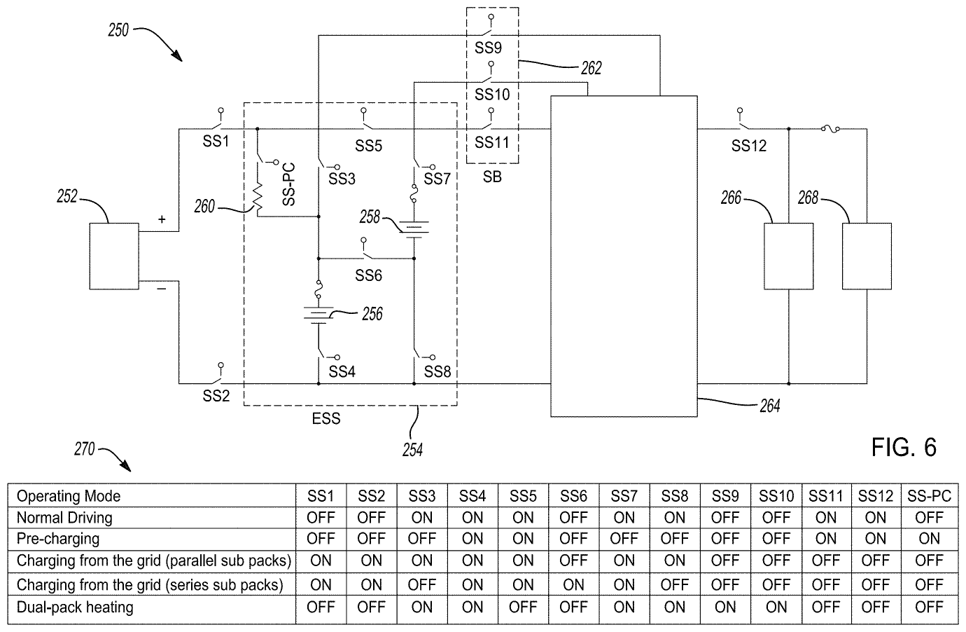

As mentioned above, a battery pack can be split into two sub-packs, where the sub-packs can be connected in series or in parallel. FIG. 6 is a depiction of an electrical architecture 250 for dual battery packs or sub-packs when the sub-packs are always connected in parallel in driving mode. The architecture 250 is configured to allow charging of the battery packs from the grid either connected in series or connected in parallel, with the selection of series or parallel connection dependent on the voltage of the battery sub-packs and the charging voltage available from the grid.

The architecture 250 depicted in FIG. 6 includes a charge port 252 configured to accept DC charging power from the power grid when the charge port 252 is connected to a charging station. Referring to FIG. 6, the electrical architecture 250 includes a charge port 252 connectable to an energy storage system (ESS) 254 through switches SS1 and SS2. The ESS 254 includes a first battery pack/sub-pack 256 and a second battery pack/sub-pack 258. The ESS 254 also includes a precharge resistor 260, as well a plurality of switches SS3, SS4, SS5, SS6, SS7, SS8, and SS-PC connected as shown in FIG. 6. The ESS 254 is connected to a DC/DC converter 264 directly as well as through a switch box 262 which includes switches SS9, SS10, and SS11 as shown in FIG. 6.

With continued reference to FIG. 6, the output of the DC/DC converter 264 is shown connected through a switch SS12 to a first electrical load 266 and a second electrical load 268. By way of non-limiting example, the first electrical load 266 may include a traction power inverter module, such as the inverter 116 connected to the traction motor 130 described above in reference to FIG. 2. Alternatively or additionally, the first electrical load 266 may include an accessory power module and/or an air conditioning compressor module. By way of non-limiting example, the second electrical load 268 may include an integrated power electronics module.

The switches SS1, SS2, SS3, SS4, SS5, SS6, SS7, SS8, SS9, SS10, SS11, and SS12 may be implemented as mechanical relays or as solid state switches. The switch SS-PC is a pre-charge contactor used to switch the resistor 260 into the circuit during a pre-charge mode to limit inrush current to the DC/DC converter. The table 270 included in FIG. 6 describes the operating state of each of the switches SS1, SS2, SS3, SS4, SS5, SS6, SS7, SS8, SS9, SS10, SS11, SS12, and SS-PC for each of the following operating modes: Normal driving, Pre-charging, Charging the batteries from the grid with the sub-packs in parallel, Charging the batteries from the grid with series sub-packs, and Dual-pack heating, i.e. controlling the DC/DC converter 264 to provide alternating current to both sub-packs to result in battery self-heating. In the table, a switch state of “OFF” means that the switch is electrically open, and a switch state of “ON” means that the switch is electrically closed.

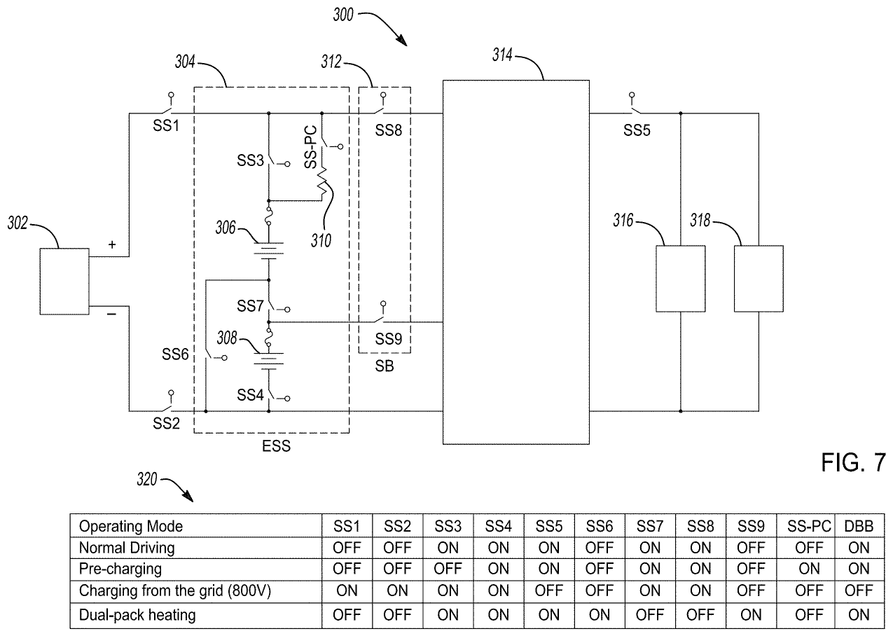

FIG. 7 is a depiction of an electrical architecture 300 for dual battery packs or sub-packs when the sub-packs are always connected in series, both in driving mode and in charging mode, according to an exemplary embodiment. The architecture 300 is configured to allow charging of the battery packs from the power grid when a charge port 302 is connected to a charging station. Referring to FIG. 7, the charge port 302 is connectable to an energy storage system (ESS) 304 through switches SS1 and SS2. The ESS 304 includes a first battery pack/sub-pack 306 and a second battery pack/sub-pack 308. The ESS 254 also includes a precharge resistor 310, as well a plurality of switches SS3, SS4, SS6, SS7, and SS-PC connected as shown in FIG. 7. The ESS 304 is connected to a DC/DC converter 314 directly as well as through a switch box 312 which includes switches SS8, and SS9 as shown in FIG. 7.

With continued reference to FIG. 7, the output of the DC/DC converter 314 is shown connected through a switch SS5 to a first electrical load 316 and a second electrical load 318. By way of non-limiting example, the first electrical load 316 may include a traction power inverter module, such as the inverter 116 connected to the traction motor 130 described above in reference to FIG. 2. Alternatively or additionally, the first electrical load 316 may include an accessory power module and/or an air conditioning compressor module. By way of non-limiting example, the second electrical load 318 may include an integrated power electronics module.

The switches SS1, SS2, SS3, SS4, SS5, SS6, SS7, SS8, and SS9 may be implemented as mechanical relays or as solid state switches. The switch SS-PC is a pre-charge contactor used to switch the resistor 310 into the circuit during a pre-charge mode to limit inrush current to the DC/DC converter. The table 320 included in FIG. 7 describes the operating state of each of the switches SS1, SS2, SS3, SS4, SS5, SS6, SS7, SS8, SS9, SS-PC, and the DC/DC converter 314 (labeled “DBB” in table 320) for each of the following operating modes: Normal driving, Pre-charging, Charging the batteries from the grid with series sub-packs (nominal charging voltage 800 V), and Dual-pack heating, i.e. controlling the DC/DC converter 314 to provide alternating current to both sub-packs to result in battery self-heating. In the table, a switch state of “OFF” means that the switch is electrically open, and a switch state of “ON” means that the switch is electrically closed.

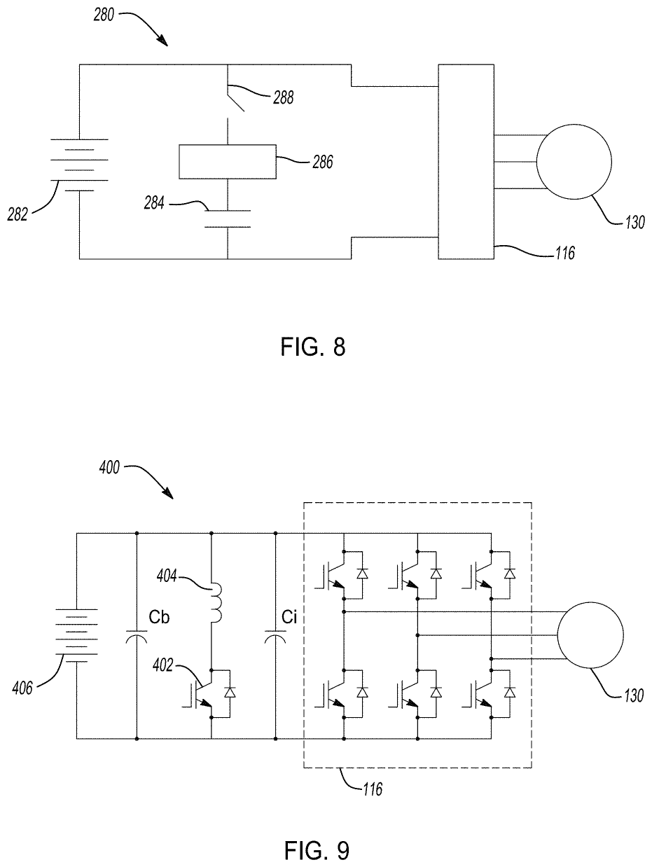

FIG. 8 is a depiction of an electrical architecture 280 that includes a battery pack 282 in combination with an ultracapacitor 284 according to an exemplary embodiment. The electrical architecture 280 shown in FIG. 8 also includes an inverter 116 connected to a traction motor 130 as described above in reference to FIG. 2. The electrical architecture 280 also includes a DC/DC converter 286 connected to the ultracapacitor 284 and to a bypass switch 288 as indicated. In the electrical architecture 280, battery self-heating is achieved with the bypass switch 288 closed by controlling the DC/DC converter to produce AC battery current. In a first portion of an AC battery current cycle the DC/DC converter 286 is controlled to transfer energy from the battery 282 to the ultracapacitor 284. In a second portion of an AC battery current cycle the DC/DC converter 286 is controlled to transfer energy from the ultracapacitor 284 to the battery 282. The bypass switch 288 is provided to allow the ultracapacitor 284 to be removed from the circuit 280 if desired during normal vehicle driving.

FIG. 9 is a depiction of an electrical architecture 400 that includes a battery 406 along with a switch 402 and an inductor 404 to generate alternating current for battery heating according to an exemplary embodiment. The electrical architecture 400 shown in FIG. 9 also includes an inverter 116 connected to a traction motor 130 as described above in reference to FIG. 2. To generate an AC current for self-heating the battery 406, the switch 402 is alternately turned on to build a magnetic field in the inductor 404 by essentially short-circuiting the battery 406 through the inductor 404, and turned off to allow the energy stored in the magnetic field of the inductor 404 to be returned to the battery 406.

A method and apparatus for battery cell self-heating of the present disclosure offers several advantages. One advantage is that battery warm-up can be significantly faster than convective heating using a resistive heating element. Efficiency improvements are also possible, with some self-heating methods being significantly more efficient than convective heating. Battery self-heating can result in more uniform heating than convective heating, resulting in improved battery life due to lower thermal gradients. Some of the disclosed approaches require little or no additional hardware compared to a baseline system, offering potential cost savings compared to a resistive heater. Preconditioning the battery temperature at low ambient temperatures requires battery energy to provide self-heating, but by enabling DC fast charging from the grid at low ambient temperatures the net charge time can be decreased even after accounting for recovery of the battery energy used to provide self-heating. Self-heating at low ambient temperatures may also enable more energy from regenerative braking to be recovered by the battery, increasing cold temperature EV driving range. Additionally, some of the disclosed approaches allow generation of sufficient heat through battery self-heating to allow the cabin of the vehicle to be preconditioned to enhance occupant comfort at low ambient temperatures.

The description of the present disclosure is merely exemplary in nature and variations that do not depart from the gist of the present disclosure are intended to be within the scope of the present disclosure. Such variations are not to be regarded as a departure from the spirit and scope of the present disclosure.

Additionally, in the claims and specification, certain elements are designated as “first”, “second”, “third”, “fourth”, “fifth”, “sixth”, and “seventh”. These are arbitrary designations intended to be consistent only in the section in which they appear, i.e. the specification or the claims or the summary, and are not necessarily consistent between the specification, the claims, and the summary. In that sense they are not intended to limit the elements in any way and a “second” element labeled as such in the claim may or may not refer to a “second” element labeled as such in the specification. Instead, the elements are distinguishable by their disposition, description, connections, and function.

What is claimed is:

1. A method for preconditioning a battery pack at cold ambient temperatures, the battery pack comprising one or more battery cells, the method comprising the steps of:
determining a desired rate of temperature rise for a battery cell,
determining a desired cell current for the battery cell based on the desired rate of temperature rise,
determining a desired pack current based on the desired cell current and a configuration of the battery pack, and
using a controller to control a current generation device to provide the desired pack current to the battery pack;
wherein the current generation device generates an alternating current.

2. The method of claim 1, wherein the desired cell current is determined based on an AC impedance of the battery cell.

3. The method of claim 1, wherein an AC impedance of the battery cell is determined based on the temperature of the battery cell and the state of charge of the battery cell.

4. The method of claim 1, wherein the current generation device comprises a boost-buck converter comprising a plurality of switches.

5. The method of claim 4, wherein a controller controls the on or off state of each of the plurality of switches.

6. The method of claim 1, wherein the current generation device comprises an inverter electrically connected to the battery pack, the inverter having a plurality of switches that are electrically connected to windings in an electric motor, and wherein the on or off state of each of the plurality of switches are controlled to generate the desired pack current to the battery pack.

7. The method of claim 1, wherein the battery pack comprises a first sub-pack and a second sub-pack, and wherein the current generation device is a DC/DC converter electrically connected to both the first sub-pack and the second sub-pack.

8. The method of claim 7, wherein the phase of the pack current delivered to the first sub-pack is opposite the phase of pack current delivered to the second sub-pack.

9. The method of claim 7, wherein the battery pack is connectable to a power grid for DC charging, wherein the first sub-pack is connected in parallel with the second sub-pack for supplying DC current to a load, and wherein a plurality of switches are controllable to a first configuration in which the first sub-pack is connected in parallel with the second sub-pack for DC charging from the grid and to a second configuration in which the first sub-pack is connected in series with the second sub-pack for DC charging from the power grid.

10. The method of claim 7, wherein the battery pack is connectable to a power grid for DC charging, wherein the first sub-pack is connected in series with the second sub-pack for supplying DC current to a load, and wherein the first sub-pack is connected in series with the second sub-pack for DC charging from the power grid.

11. The method of claim 1, wherein the current generation device comprises a DC/DC converter electrically connected to an ultracapacitor.

12. The method of claim 1, wherein the current generation device comprises a switch in series with an inductor.

13. The method of claim 1, wherein the alternating current is generated at a frequency that is determined based on the temperature of the battery cell and the state of charge of the battery cell.

14. The method of claim 13, wherein the frequency is between 10 Hz and 1000 Hz.

15. The method of claim 1, wherein the battery pack is configured to provide power to a traction motor in an electric vehicle.

16. A controller comprising a processor and a non-transitory machine-readable storage device containing instructions that, when executed by the processor, cause the processor to execute the method of claim 1.

17. An automotive vehicle, comprising:
a traction motor system;
a battery pack comprising one or more battery cells electrically connectable to the traction motor system;
a current generation device configurable to deliver AC current to the battery pack; and
a controller electrically connected to the current generation device, the controller configured to:
determine a desired rate of temperature rise for a battery cell,
determine a desired cell current based on the desired rate of temperature rise,
determine a desired pack current based on the desired cell current and a configuration of the battery pack, and
control the current generation device to provide the desired pack current to the battery pack from the current generation device.
